(19) United States
(12) Patent Application Publication
(10) Pub. No.: US 2006/0020966 A1
(43) Pub. Date: Jan. 26, 2006

(54) Program guide with integrated progress bar

(76) Inventor: Thomas Poslinski, San Diego, CA (US)

Correspondence Address: Steven L. Nichols;Rader, Fishman, & Grauer PLLC, River Park Corporate Center One, 10653 S River Front Pkwy., Ste. 150, South Jordan, UT, 84095, US

(21) Appl. No.: 10/897,145

(22) Filed: Jul. 22, 2004

(51) Int. Cl. H04N 5/445; G09B 25/00

(52) U.S. Cl. 725/37; 434/365

(57) ABSTRACT

A method and system for providing information about media content being broadcast on a channel during a number of time segments. A graphical user interface including a single channel program guide and a progress bar is displayed on the viewing screen of a display device. The single channel program guide shows program information corresponding to each of a plurality of media content instances included in the media content. The progress bar graphically represents the duration of a recorded portion of the media content that has been stored in a live cache buffer.

### BACKGROUND

The advent of computers, interactive electronic communication, the Internet, and other advances in the digital realm of consumer electronics have resulted in a great variety of programming, recording, and viewing options for users who view media content such as television programs. In implementing such enhanced programming, the set-top box (STB) has become an important computing device for accessing media content services and the media content within those services. In addition to supporting traditional analog broadcast video functionality, STBs may also support an increasing number of two-way digital services such as video-on-demand and personal video recording.

An STB is typically connected to a cable or satellite, or generally, a subscriber television system, and includes hardware and software necessary to provide the functionality of the subscriber television system at the user's site. The STB typically includes a processor, communication components, and memory and is connected to a television or other display device, such as a personal computer. While many STBs are stand-alone devices that are externally connected to a television, an STB and/or its functionality may be integrated into a television or personal computer or even an audio device such as a programmable radio, as will be appreciated by those of ordinary skill in the art.

STBs are typically capable of providing users with a very large number and variety of media content choices. As the number of available media content choices increases, viewing conflicts arise whereby the user must choose between watching two or more media content instances (e.g. discrete, individual instances of media content such as, for a non-limiting example, a particular television show or “program”), all of which the user may like to view. Further, because of the large number of viewing choices, the user may miss viewing opportunities. Buffering of media content instances in memory or other storage device (e.g. hard disk drive) coupled to the STB has provided some relief from the conflict in viewing choices while providing personal video recording functionality. However, current buffering mechanisms for personal video recording are confusing to the user.

As mentioned, an STB may include a personal video recording (PVR) application that provides for media content recording functionality by enabling the temporary writing to, and if requested, more permanent recording to a storage device. A PVR application is also known as a Digital Video Recording (DVR) application. The PVR application may be integrated into the STB or it may be a stand-alone unit known as a personal video recorder. A typical PVR application allows the user to view the media content in trick play modes. Trick play modes allow the user to watch media content in a non-linear fashion by recording the media content in a temporary memory buffer, often called a live cache buffer, and then replaying the recorded media content in a manner other than a normal, sequential replay. Trick play modes include, but are not limited to, slow motion, fast motion, reverse play, fast forward play, instant replay, jumping, pausing of live broadcast, and scanning.

In a typical PVR application, a progress bar is a graphical tool that is used to illustrate how much media content has been recorded during a particular time window. The length of the progress bar may correspond to the amount of media content that has been recorded in a live cache buffer. However, a number of difficulties arise in operating a STB having a PVR application. For example, it is currently difficult for a user to display program information corresponding to the media content that is currently being recorded and tracked by a progress bar. Furthermore, it is currently difficult to use the permanent record function and other functions of a PVR application when more than one media content instance is stored in the live cache buffer.

### SUMMARY

In one of many possible embodiments, the present invention provides a method and system for providing information about media content being broadcast on a channel during a number of time segments. A graphical user interface (GUI) including a single channel program guide and a progress bar is displayed on the viewing screen of a display device. The single channel program guide shows program information corresponding to each of a plurality of media content instances included in the media content. The progress bar graphically represents the duration of a recorded portion of the media content that has been stored in a live cache buffer.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a block diagram of an exemplary set-top box according to one exemplary embodiment of the present invention.

FIG. 2 is an exemplary user input device may be used in connection with the present invention according to one exemplary embodiment of the present invention.

FIG. 3 illustrates a graphical user interface (GUI) displayed on a display device that assists the user in navigating to, and between, media content instances stored in the live cache buffer according to one exemplary embodiment of the present invention.

FIG. 4 illustrates a GUI displayed on a display device wherein the current time has changed and wherein the entire progress bar has shifted to the right according to one exemplary embodiment of the present invention.

FIG. 5 illustrates a media content instance that has been paused according to one exemplary embodiment of the present invention.

FIG. 6 is a flow chart illustrating an exemplary method of displaying a progress bar that is integrated into a single channel program guide on a display device according to one exemplary embodiment of the present invention.

FIG. 7 illustrates that the user may designate which media content instance is to be recorded by using the single channel program guide with the superimposed progress bar according to one exemplary embodiment of the present invention.

FIG. 8 is a flow chart illustrating an exemplary method of permanently recording a media content instance that is stored in a live cache buffer according to one exemplary embodiment of the present invention.

Throughout the drawings, identical reference numbers designate similar, but not necessarily identical, elements.

### DETAILED DESCRIPTION

A method and system for providing information about media content being broadcast on a channel during a number of time segments are described herein. A graphical user interface (GUI) including a single channel program guide and a progress bar is displayed on the viewing screen of a display device. The single channel program guide shows program information corresponding to each of a plurality of media content instances included in the media content. The progress bar graphically represents the duration of a recorded portion of the media content that has been stored in a live cache buffer. The GUI allows a user to easily navigate through various media content instances (e.g. television programs) and/or view the media content instances using trick play modes. The GUI further allows a user to easily designate a particular media content instance as one that is to be permanently recorded.

In the following description, for purposes of explanation, numerous specific details are set forth in order to provide a thorough understanding of the present system and method. It will be apparent, however, to one skilled in the art that the present system and method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

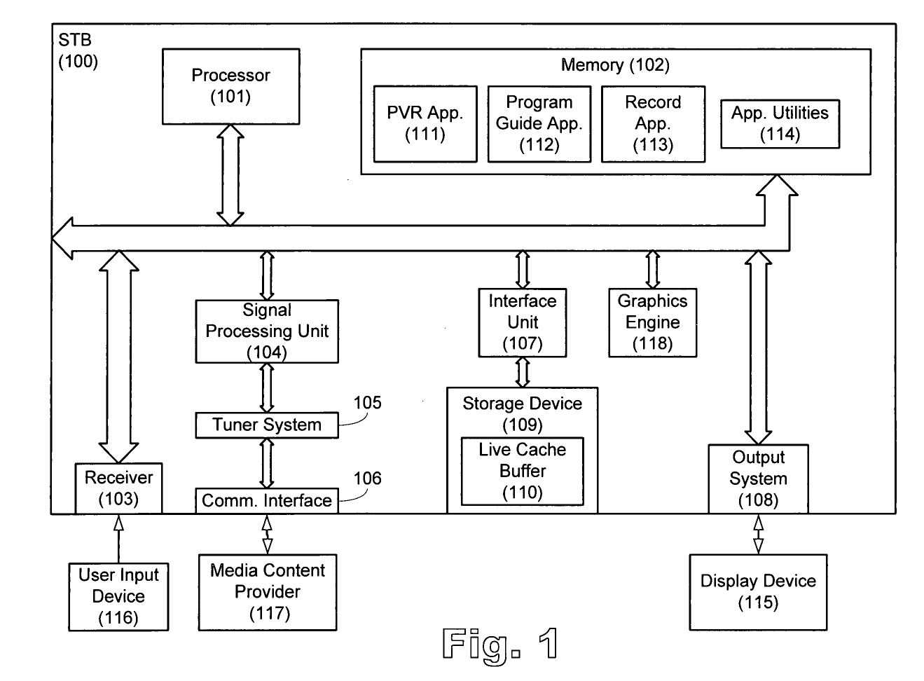

FIG. 1 is a block diagram of an exemplary set-top box (STB) (100) according to an exemplary embodiment of the present invention. An STB (100) may also be referred to as a home communication terminal (HCT) or as a digital home communication terminal (DHCT). As used herein and in the appended claims, unless otherwise specifically denoted, the term “set-top box” will be used to refer expansively to all possible receivers that receive and decode digital and/or analog media content. It will be understood that the STB (100) shown in FIG. 1 is merely illustrative and should not be construed as implying any limitations upon the scope of the preferred embodiments of the invention.

As shown in FIG. 1, the STB (100) may include a communication interface (106) configured to receive media content from a media content provider (117). The media content provider (117) may provide various types of media content via a satellite or cable system (not shown). The media content may include, but is not limited to, television programs, pay-per-view services, video-on-demand programming, Internet services, and audio programming.

The STB (100) may also include a tuner system (105) configured to tune into a particular television channel or frequency to display media content and for sending and receiving various types of data or media content to and from the media content provider (117). According to an exemplary embodiment of the present invention, the tuner system (105) may include multiple tuners such that multiple channels of media content may be processed and/or shown on a display device (115). For example, the tuner system (105) may include a first tuner configured to receive an analog video signal corresponding to a first media content instance and a second tuner configured to simultaneously receive a digital compressed stream corresponding to a second media content instance. The tuner system (105) may have any number of tuners configured to receive any kind of media content according to one embodiment of the present invention.

The STB (100) may also include one or more processors, such as processor (101) configured to control operations of the STB (100), and an output system (108) configured to drive the display device (115). The display device (115) may be a television, computer monitor, or any other device configured to display or play the media content. The STB (100) may also include a signal processing unit (104) configured to process the media content. The signal processing unit (104) may include a demodulating and parsing system (not shown) for demodulating and parsing the media content. In one embodiment, the STB (100) may include multiple signal processing units (104) each corresponding to one of the tuners in the tuner system (105). The STB (100) may also include one or more compression and/or multiplexing units (not shown) for multiplexing various media content streams into a transport stream or the like.

One or more programmed applications (111-113) may be executed by a user of the STB (100) by utilizing the computing resources in the STB (100). The applications, or application clients, may be resident in memory (102). The memory (102) may be FLASH memory, DRAM memory, or a combination of FLASH and DRAM memory, for example. Applications (111-113) stored in memory (102) may be executed by the processor (101). Data generated by an application may be stored in the memory (102) or in a storage device (109) during the course of application execution. The memory (102) may also include application utilities (114) useful to the applications. The utilities (114) may include a timer manager, a configuration manager, a database manager, and other utilities depending on the particular applications included in the STB (100).

One of the applications may be a program guide application (112) configured to generate a single channel program guide that is displayed on the display device (115). An exemplary program guide is a graphical user interface (GUI) that performs various functions including allowing a user to select and view program information associated with various media content. Another one of the applications may be a record application (113). The record application (113) may be configured to permanently and/or temporarily record media content in one or more buffers. The program guide and record applications (112, 113) will be described below.

The STB (100) may also include a personal video recording (PVR) application (111). According to an exemplary embodiment, the PVR application (111) may be integrated into the STB (100), as shown in FIG. 1, or it may be a stand-alone unit. A stand-alone PVR may be coupled to an STB (100) or it may be used in place of an STB (100). As used herein and in the appended claims, the term “PVR application” will be used to refer to any application or device configured to record media content and/or allow the viewing of media content in trick play mode. Trick play modes include, but are not limited to, slow motion, fast motion, reverse play, fast forward play, instant replay, jumping, pausing of live broadcast, and scanning. In the examples contained herein, it will be assumed that the PVR application (111) is integrated into the STB (100) for illustrative purposes only. In one embodiment, the program guide application (112) and/or the record application (113) may be integrated into the PVR application (111).

The PVR application (111) provides for media content recording functionality by enabling the temporary writing to, and if requested, more permanent recording to a storage device (109). The storage device (109) may be a hard drive, optical disc, or other non-volatile storage unit. The storage device (109) of FIG. 1 is shown to be a part of the STB (100) for illustrative purposes only. It will be understood that the storage device (109) may be an external storage device.

The STB (100) may also include a graphics engine (118) configured to generate graphics to be displayed on the display device (115). The graphics may include a single channel program guide, a progress bar, and other applications. For example, the PVR and program guide applications (111, 112) may cause the graphics engine (118) to generate a progress bar superimposed on a single channel program guide, as will be explained in detail below.

In one exemplary embodiment, media content received at the tuner (105) is temporarily buffered, or stored, in a live cache buffer (110). If there are multiple tuners (105), there may be a live cache buffer (110) corresponding to each of the tuners (105). As shown in FIG. 1, the live cache buffer (110) may be a part of the storage device (109) (e.g. a reserved portion of a hard dive). In an alternative embodiment (not shown), the live cache buffer (110) may reside in memory (102) or in a storage device external to the STB (100). Media content received into the live cache buffer (110) has a temporary recording designation. In other words, the media content stored in the live cache buffer (110) will either be deleted or retained through election by the user as a permanent recording. A permanent recording will be understood to mean media content that is stored for an extended period of time as decided by the user. Permanent recordings may be stored in non-buffer portions of the storage device (109). The conversion of a media content instance from being temporarily stored in the live cache buffer (110) to being permanently recorded will be discussed below.

As will be understood by one skilled in the art, there is a time duration associated with the live cache buffer (110) corresponding to the quantity of data that the live cache buffer (110) is configured to store. This time duration will be referred to as a “live cache time window.” The length or duration of the live cache time window may be specified by the user, according to one embodiment. For example, the user may specify a live cache time window of 30 minutes. In this example, the live cache buffer (110) will be configured to store a quantity of media content data representing 30 minutes. The length of the live cache time window as specified by the user may vary as best serves a particular application and may be limited by the size of the storage unit of which the live cache buffer (110) is a part and by the capabilities of the STB (100) and its components.

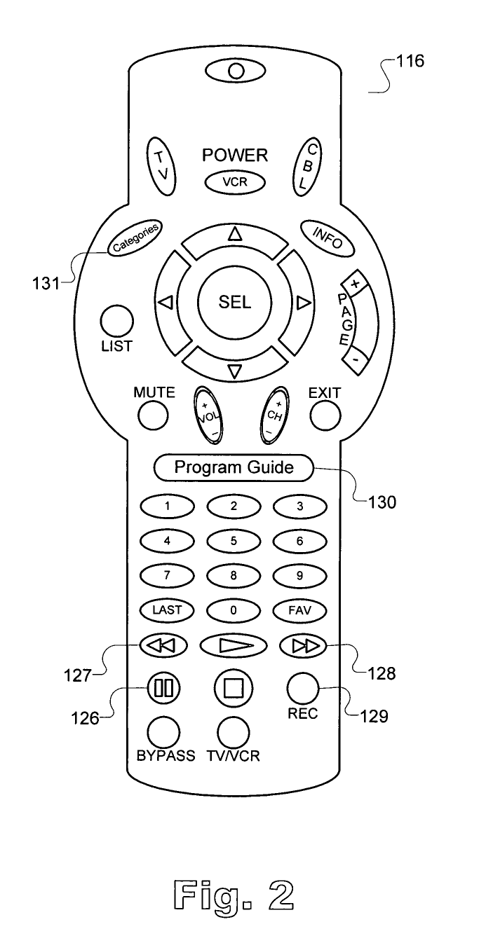

An exemplary user input device (116) is shown in FIG. 2. The input device (116) may be a remote control, as shown in FIG. 2, or any other type of user input device such as a group of buttons (not shown) affixed to the STB (100), a touch screen input device (not shown) displayed on the display device (115), a keyboard device, or a voice activated device. The input device (116) may be configured to allow a user to control viewing options and trick play modes of the media content. For example, rewind (127) and fast-forward buttons (128) enable a user to access buffered media content instances in the live cache buffer (110). A record button (129) may also be included which enables the user to designate as permanently recorded any media content instance buffered in the live cache buffer (110). A pause button (126) may enable the user to pause a media content instance, or pause during a search for a particular media content instance. A program guide button (130) may be configured to evoke the display of a program guide on the display device (115). Many alternative methods of providing user input may be used including a remote control device with different buttons and/or button layouts. The embodiments of the invention described herein are not limited by the type of device used to provide user input.

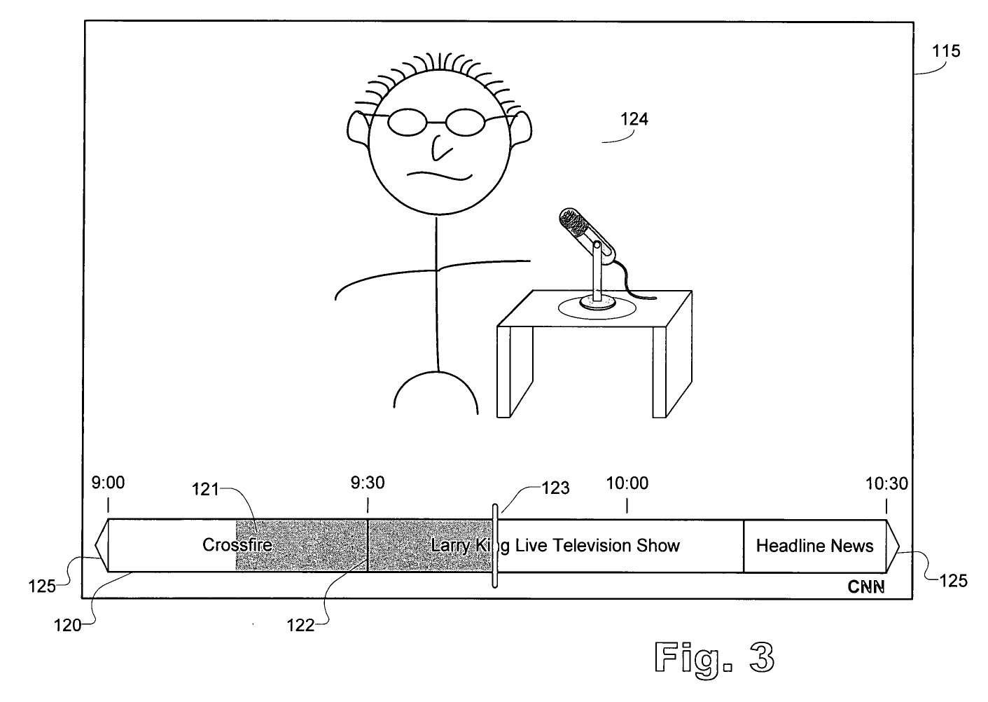

FIG. 3 illustrates an exemplary embodiment of the present invention wherein a GUI is displayed on the display device (115) that assists the user in navigating to, and between, media content instances stored in the live cache buffer (110). The display device (115) in FIG. 3 is a television for illustrative purposes. Furthermore, the tuner system (105) is tuned to a channel carrying CNN programming for illustrative purposes.

Specifically, as shown in FIG. 3, the GUI includes a progress bar (121) integrated into a single channel program guide (120). As shown in FIG. 3, the progress bar (121) is superimposed on top of the single channel program guide (120) and may be shaded or of a unique color such that a user may visually distinguish the progress bar (121) from the single channel program guide (120). In an alternative embodiment, the progress bar (121) may be positioned above or below the single channel program guide (120) instead of being superimposed on top of the single channel program guide (120).

According to one embodiment, as shown in FIG. 3, the single channel program guide (120) and the progress bar (121) are superimposed on the viewing portion of the display device (115) such that the viewer may simultaneously view the media content instance (124), the single channel program guide (120), and the progress bar (121). The single channel program guide (120) and the progress bar (121) are preferably located in the bottom half of the viewing portion of the display device (115), as shown in FIG. 3, so as not to overly interfere with the current media content instance (124). However, in an alternative embodiment, the single channel program guide (120) and the progress bar (121) may be located at any position on the viewing portion of the display device (115). Furthermore, the exact location of the single channel program guide (120) and the progress bar (121) may be specified by the user.

As shown in FIG. 3, the single channel program guide (120) may be displayed in a grid-like style with a number of blocks of program information corresponding to the media content being broadcast or shown on the corresponding channel. For example, the single channel program guide (120) shows program information corresponding to three media content instances—the television programs Crossfire, Larry King Live Television Show, and Headline News. As shown in FIG. 3, the program information shown may include the title of the media content instances. In addition, the channel program guide (120) may also show the name of the channel currently being displayed, as shown in FIG. 3, and other types of program information (not shown). Program information may include, but is not limited to, genre information, ratings information, program start and stop times, program descriptions, and other pertinent program information text. In one embodiment, the program information text is always viewable to the user while the single, channel program guide (120) is being displayed.

In one embodiment, a time scale may be included in the single channel program guide (120). The time scale is relative to the time segmentation of the single channel program guide (120). For example, in FIG. 3, program information is shown for three one-half hour time segments starting at 9:00 and ending at 10:30. The time scale and number of time segments included in the single channel program guide (120) may vary as best serves a particular application and may be specified by the user. For example, each time segment may represent an hour instead of a half hour if the user wants to view program information for a larger time window.

Furthermore, as shown in FIG. 3, the program boundaries may be represented by vertical separators (122). For example, a vertical separator (122) is located at a position within the single channel program guide (120) corresponding to 9:30, the time when Crossfire ends and when Larry King Live begins. In one embodiment, the vertical separators are always viewable to the user while the single channel program guide (120) is being displayed.

In one embodiment, the start time of the single channel program guide (120) corresponds to the beginning of a time segment that is previous in time to the time segment of which the current time is a part. For example, if the current time is 9:45 (illustrated by the progress indicator (123) in FIG. 3) and each time segment is a half hour, the start time of the single channel program guide (120) is 9:00, which is the beginning of the time segment of which 9:15 is a part. By including this previous time segment in the single channel program guide (120), the progress bar (121) may be properly displayed, as will be described below. Furthermore, scroll bars (125) may be included so that the user may scroll backwards and forwards in time to see program information at times not currently being displayed. The scroll bars (125) may be implemented and displayed in a variety of manners that are known in the art.

The progress bar (121) graphically represents or indicates the amount of media content that has been recorded in the live cache buffer (110; FIG. 1). For example, the progress bar (121) of FIG. 3 shows the user that the PVR application (111; FIG. 1) began recording the media content being shown on CNN at approximately 9:15. As time progresses, the length of the progress bar (121) increases to visually indicate to the user the amount, in minutes, of media content that has been recorded in the live cache buffer (110). In one embodiment, the right-most edge of the progress bar (121) indicates the current time. For example, in FIG. 3, the right-most edge of the progress bar (121) is positioned at approximately 9:45. Thus, the current time in FIG. 3 is 9:45. The amount of media content that may be stored in the live cache buffer (110) (i.e. the live cache time window) is preferably user-definable and is limited by the size of the storage unit of which the live cache buffer (110) is a part and by the capabilities of the STB (100) and its components. Typical durations of the live cache time window include, but are not limited to a half hour, an hour, two hours, or three hours. The length of the live cache time window will vary as best serves a particular application. For example, the length of the live cache window in FIG. 3 is a half hour.

In one embodiment, the PVR application (111) also stores in the live cache buffer (110) or in a separate database the program information corresponding to each of the media content instances that are recorded in the live cache buffer (110). For example, the live cache buffer (110) or a program information database in the illustrative situation of FIG. 3 contains program information corresponding to the media content instances Crossfire and Larry King Live.

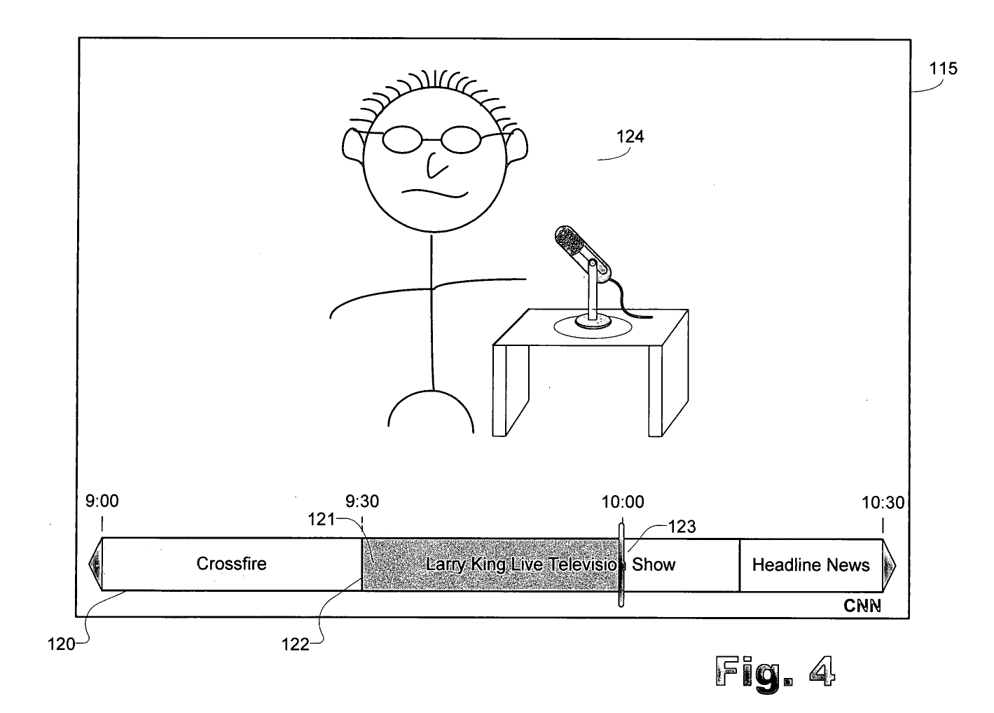

Once the progress bar (121) has reached a length equal to the defined live cache time window, the entire progress bar (121) moves across the single channel program guide (120) such that the right edge of the progress bar (121) stays with the current time. For example, if the current time in FIG. 3 changes from 9:45 to 10:00, the entire progress bar (121) shifts to the right such that the progress bar (121) starts at 9:30 and ends at 10:00, as shown in FIG. 4. Furthermore, as the current time progresses, previously recorded media content residing in the live cache buffer (110) is erased in a first-in first-out (FIFO) fashion to make space in the live cache buffer (110) for the media content instance being currently shown.

Referring again to FIG. 3, a progress indicator (123) may be displayed as part of the progress bar (121). The progress indicator (123) graphically indicates to the user the location in the live cache buffer (110) of the media content instance that is currently being displayed. For example, in FIG. 3, the progress indicator (123) indicates that the user is viewing the media content instance in real-time as it is being buffered.

The progress indicator (123) may be a solid line, as shown in FIG. 3. In an alternative embodiment, the progress indicator (123) may be any shape, such as a triangle, and may be located above, below, or on top of the progress bar (121). In general, the progress indicator (123) may be any graphical symbol that allows the user to quickly identify the location in the live cache buffer (110) of the media content instance that is currently being displayed.

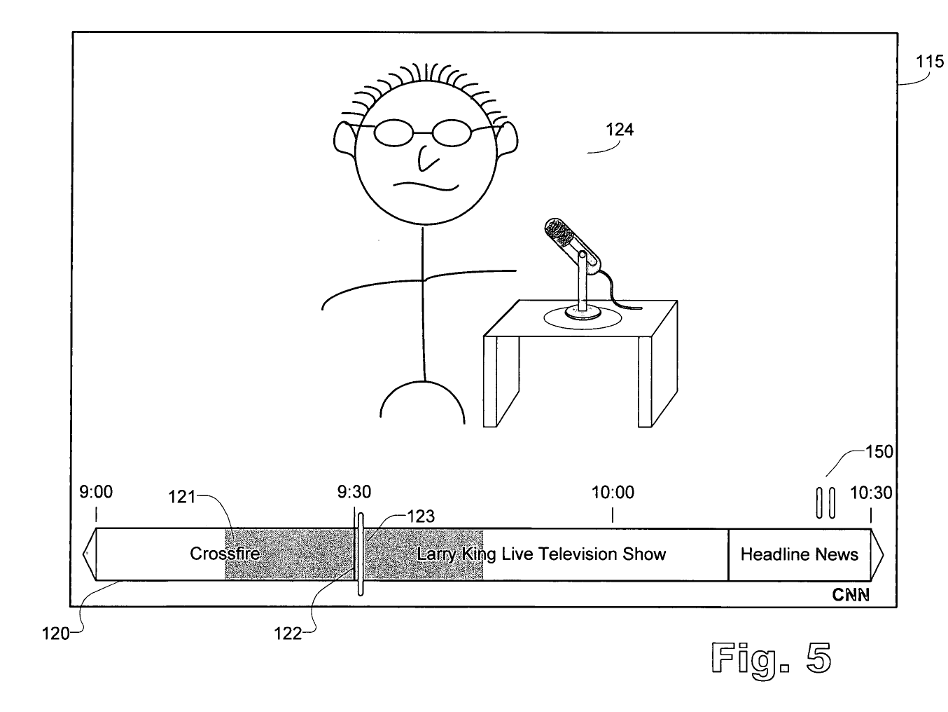

The progress indicator (123) is especially useful to the user when the user is viewing the media content instance in trick play mode. For example, FIG. 5 illustrates a media content instance that has been paused shortly after 9:30, as shown by the pause symbol (150). As shown in FIG. 5, the progress indicator (123) is positioned shortly after 9:30 on the progress bar (121). As time progresses, the progress bar (121) either grows or moves across the single channel program guide (120) while the progress indicator (123) stays at the position shortly after 9:30. The user may easily move the position of the progress indicator (123) and view different portions of the media content stored in the corresponding live cache buffer (110).

As mentioned, the duration of the live cache time window may be defined by the user. If the defined live cache time window duration is larger than the length of the displayed single channel program guide (120), the user may use the scroll features already described to quickly navigate the progress indicator (123) to a desired location.

In one embodiment, the single channel program guide (120) and the progress bar (121) may be displayed when a trick mode is initiated by the user. In an alternative embodiment, the user may invoke the display of the single channel program guide (120) and the progress bar (121) by pressing a button on the input device (116).

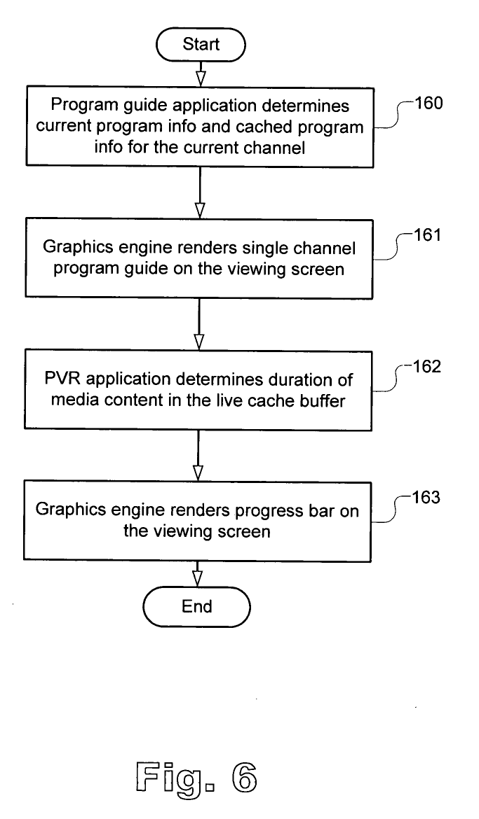

FIG. 6 is a flow chart illustrating an exemplary method of displaying a progress bar (121; FIG. 3) that is integrated into a single channel program guide (120; FIG. 3) on a display device (115; FIG. 3), according to an exemplary embodiment of the present invention. The method described in connection with FIG. 6 may be performed when the user invokes a trick mode, for example. The steps shown in FIG. 6 may be performed in any order and may be performed by various applications. Furthermore, the steps are exemplary only and may be added to or modified as best serves a particular application.

As shown in FIG. 6, the program guide application (or, alternatively, the PVR application) determines the current program information and the cached program information for the currently tuned channel (step 160). The cached program information may be stored in the live cache buffer or in a program information database. Thus, the program guide application may determine the cached program information by reading the information from the live cache buffer or from the program information database.

The graphics engine then renders a single channel program guide on the viewing screen (step 161). The viewing screen is a part of the display device. The program information determined in step 160 is included in the single channel program guide rendered in step 161. The PVR application then determines the duration of the media content in the live cache buffer (step 162) so that the graphics engine may render an appropriately sized progress bar on the viewing screen (step 163).

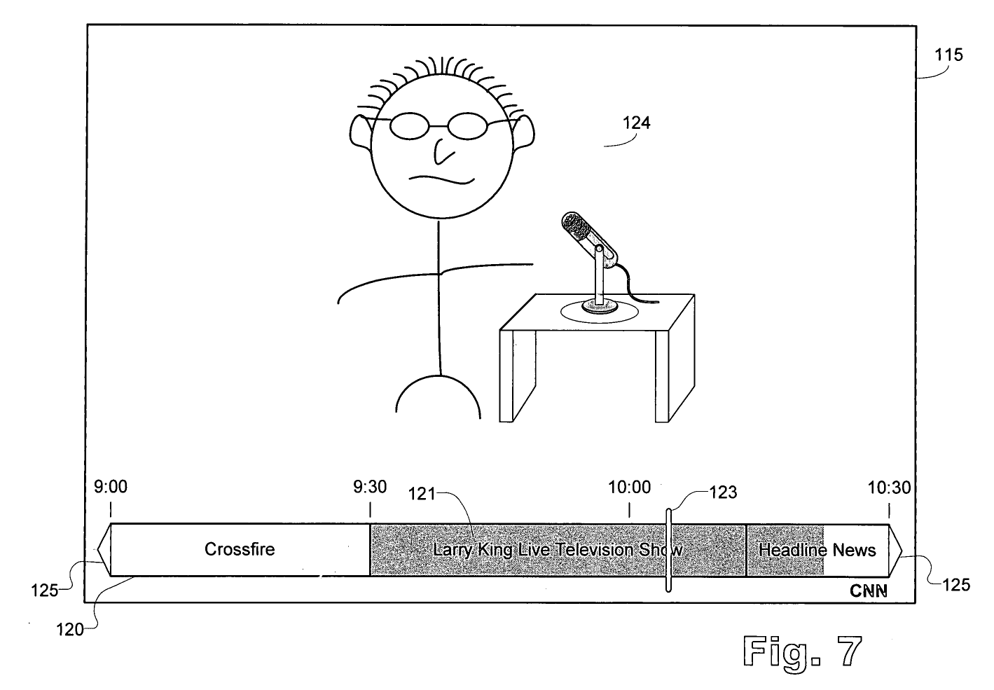

In one embodiment of the present invention, the user may permanently record any of the media content instances stored in the live cache buffer (110; FIG. 1) and their corresponding program information. FIG. 7 illustrates an exemplary embodiment wherein the user may designate which media content instance is to be recorded by using the single channel program guide (120) with the superimposed progress bar (121). In one embodiment, the user may move the progress indicator (123) such that it is positioned at any point within the media content instance that is to be permanently recorded. Once the progress indicator (123) is positioned within the media content that is to be permanently recorded, the user may press a record button (129; FIG. 2) on a user input device (e.g. 116; FIG. 2). The data stored in the live cache buffer (110) that corresponds to the selected media content instance is then copied from the live cache buffer (110) into a permanent buffer by the record application (113). The permanent buffer may be a part of the storage device (109; FIG. 1), for example.

For example, as shown in FIG. 7, the Larry King Live Television Show and a portion of Headline News have been temporarily recorded in the live cache buffer (110). If the user desires to permanently record the Larry King Live Television Show, he or she may move the progress indicator (123) to any position between the beginning and end of the Larry King Live Television Show, as indicated by the single channel program guide (120). The user may then simply press the record button (129; FIG. 2) and the program and its corresponding program information are copied from the live cache buffer (110) to a permanent buffer by the record application (113).

In another embodiment, if the user desires to permanently record a media content instance that is currently being live cache buffered (e.g. Headline News in FIG. 7), the user may move the progress indicator (123) to any position within the desired media content instance or to the right-most edge of the progress bar (121). The user may then select the record button (129; FIG. 2). The record application (113; FIG. 1) may then copy the portion of the media content instance that is already in the live cache buffer (110; FIG. 1) into a permanent buffer. In one embodiment, the remaining portion of the media content instance is recorded in both the live cache buffer (110; FIG. 1) and in the permanent buffer as the media content instance is shown on the channel. In an alternative embodiment, the record application (113; FIG. 1) may not permanently record the remaining media content instance until the media content instance is completely stored in the live cache buffer (110; FIG. 1).

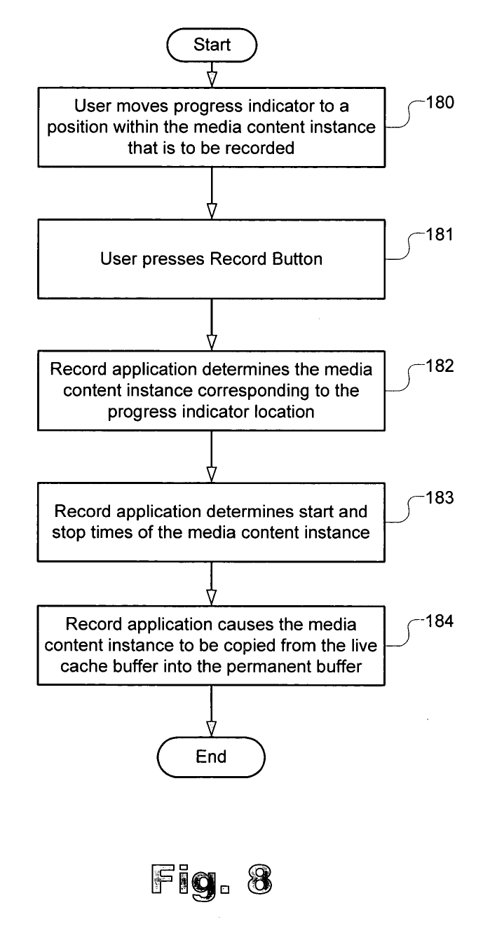

FIG. 8 is a flow chart illustrating an exemplary method of permanently recording a media content instance that is stored in a live cache buffer. The method utilizes a single channel program guide (120; FIG. 7) and a progress bar (121; FIG. 7) that are displayed on the viewing screen of a display device (115; FIG. 7). The steps shown in FIG. 8 may be performed in any order and may be performed by various applications. Furthermore, the steps are exemplary only and may be added to or modified as best serves a particular application.

As shown in FIG. 8, the user first moves a progress indicator to a position within media content instance that is to be recorded (step 180). The user then presses a record button (step 181). Once the record button is pressed, the record application determines the media content instance corresponding to the location of the progress indicator (step 182). In one embodiment, the record application queries the PVR application which in turn dereferences the location of the progress indicator to a real time stamp. The real time stamp may be used to determine the media content instance (step 182).

Once the media content instance has been determined (step 182), the record application determines the start and stop times of the media content instance (step 183). In one embodiment, the record application may perform this step by dereferencing the real time stamp against the stored program information. The record application may now copy the media content instance from the live cache buffer into the permanent buffer (step 184). In one embodiment, the allocation blocks associated with the new record block shall be extracted from the live cache file entry. These allocation blocks shall be moved to a new file specified by the record application.

The PVR, program guide, and record applications (111-113) may be implemented in hardware, software, firmware, or a combination thereof. For example, the applications (111-113) may be implemented in software or firmware that is stored in a memory and that is executed by a suitable instruction execution system. If implemented in hardware, as in an alternative embodiment, the PVR, program guide, and record applications (111-113) may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The PVR, program guide, and record applications (111-113) may comprise an ordered listing of executable instructions for implementing logical functions and may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. A “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

What is claimed is:

1. A method of providing information about media content being broadcast on a channel during a number of time segments, said method comprising:
displaying a single channel program guide, said single channel program guide showing program information corresponding to each of a plurality of media content instances included in said media content; and
displaying a progress bar to graphically represent the duration of a recorded portion of said media content that has been stored in a live cache buffer.

2. The method of claim 1, further comprising displaying said media content at the same time as said single channel program guide and said progress bar.

3. The method of claim 1, wherein said media content instances comprise television programs.

4. The method of claim 1, wherein said number of time segments is user-definable.

5. The method of claim 1, wherein the duration of each of said time segments is user-definable.

6. The method of claim 1, wherein said step of displaying said single channel program guide further comprises displaying a time scale corresponding to said number of time segments.

7. The method of claim 1, wherein said program information comprises a title for each of said plurality of said media content instances.

8. The method of claim 1, further comprising displaying said program information such that said program information is superimposed on top of said single channel program guide.

9. The method of claim 1, further comprising displaying one or more scroll bars configured to scroll said single channel guide backwards and forwards such that additional time segments and corresponding program information are visible to a user.

10. The method of claim 1, wherein said step of displaying said progress bar comprises superimposing said progress bar on top of said single channel program guide.

11. The method of claim 1, wherein said live cache buffer is configured to store a pre-determined quantity of said media content, said pre-determined quantity corresponding to a live cache time window.

12. The method of claim 11, wherein the size of said live cache time window is user-definable.

13. The method of claim 1, wherein said step of displaying a progress bar further comprises increasing the length of said progress bar as time advances.

14. The method of claim 1, wherein said progress bar is further configured to allow a user to view said recorded portion of said media content in a trick play mode.

15. The method of claim 1, further comprising displaying a progress indicator corresponding to a position in time of a particular media content instance currently being displayed, said position in time relative to said duration of said recorded portion of said media content.

16. The method of claim 15, wherein said progress indicator is a vertical line superimposed on top of said displayed single channel program guide.

17. The method of claim 15, wherein said progress indicator is a triangle.

18. The method of claim 15, further comprising permanently recording in a permanent buffer one of said media content instances that has been stored in said live cache buffer.

19. The method of claim 18, wherein said step of permanently recording one of said media content instances comprises:
positioning said progress indicator at a location within any portion of said progress bar corresponding to said one of said media content instances;
receiving an instruction to record from a user input device; and
copying said one of said media content instances from said live cache buffer to said permanent buffer.

20. The method of claim 19, wherein said step of copying said one of said media content instances comprises:
dereferencing said location of said progress indicator to a real time stamp;
determining a start time and a stop time of said one of said media content instances by comparing said real time stamp to said program information; and
copying data corresponding to media content between said start and stop times from said live cache buffer to said permanent buffer.

21. The method of claim 15, wherein said step of permanently recording in a permanent buffer one of said media content instances that has been stored in said live cache buffer further comprises permanently recording said program information corresponding to said one of said media content instances.

22. The method of claim 1, further comprising storing said program information in a program information database.

23. The method of claim 1, further comprising storing said program information in said live cache buffer.

24. A system for providing information about media content being broadcast on a channel during a number of time segments, said media content including a plurality of media content instances, said system comprising:
a memory unit including a number of applications;
a storage device including a live cache buffer for storing a temporarily recorded portion of said media content;
a graphics engine configured to render graphics that are displayed on a display device; and
a processor configured to use one or more of said number of applications to cause said graphics engine to display a single channel program guide and a progress bar;
wherein said single channel program guide graphically shows program information corresponding to each of said plurality of media content instances, wherein said progress bar graphically represents the duration of said recorded portion of said media content that has been temporarily stored in said live cache buffer.

25. The system of claim 24, wherein said number of applications includes a program guide application configured to generate said single channel program guide.

26. The system of claim 24, wherein said number of applications includes a personal video recording (PVR) application configured to generate said progress bar.

27. The system of claim 24, wherein said media content is displayed at the same time as said single channel program guide and said progress bar.

28. The system of claim 24, wherein said media content instances comprise television programs.

29. The system of claim 24, wherein said number of time segments is user-definable.

30. The system of claim 24, wherein the duration of each of said time segments is user-definable.

31. The system of claim 24, wherein said single channel program guide further shows a time scale corresponding to said number of time segments.

32. The system of claim 24, wherein said program information comprises a title for each of said plurality of said media content instances.

33. The system of claim 24, wherein said program information is superimposed on said on top of said single channel program guide.

34. The system of claim 24, wherein said processor is further configured to cause said graphics engine to display one or more scroll bars configured to scroll said single channel guide backwards and forwards such that additional time segments and corresponding program information are visible to a user.

35. The system of claim 24, wherein said progress bar is superimposed on top of said single channel program guide.

36. The system of claim 24, wherein said live cache buffer is configured to store a pre-determined quantity of said media content, said pre-determined quantity corresponding to a live cache time window.

37. The system of claim 36, wherein the size of said live cache time window is user-definable.

38. The system of claim 24, wherein the length of said progress increases as time advances.

39. The system of claim 24, wherein said progress bar is further configured to allow a user to view said temporarily recorded portion of said media content in a trick play mode.

40. The system of claim 24, wherein said processor is further configured to cause said graphics engine to display a progress indicator corresponding to a position in time of a particular media content instance currently being displayed on said display device, said position in time relative to said duration of said temporarily recorded portion of said media content.

41. The system of claim 40, wherein said progress indicator is a vertical line superimposed on top of said displayed single channel program guide.

42. The system of claim 40, wherein said progress indicator is a triangle.

43. The system of claim 40, wherein said system further comprises a permanent buffer, wherein said processor uses one of said number of applications to permanently record in said permanent buffer one of said media content instances that has been stored in said live cache buffer.

44. The system of claim 43, wherein said number of applications includes a record application configured to permanently record in said permanent buffer said one of said media content instances that has been stored in said live cache buffer.

45. The system of claim 44, wherein a user invokes said permanent recording of said one of said media content instances by:
positioning said progress indicator to a location within any portion of said progress bar corresponding to said one of said media content instances; and
sending a record command to said record application with a user input device.

46. The system of claim 45, wherein said user input device is a remote control.

47. The system of claim 44, wherein said record application is configured to:
dereference said location of said progress indicator to a real time stamp;
determine a start time and a stop time of said one of said media content instances by comparing said real time stamp to said program information; and
copying data corresponding to media content between said start and stop times from said live cache buffer to said permanent buffer.

48. The system of claim 44, wherein said record application further permanently records said program information corresponding to said one of said media content instances.

49. The system of claim 43, wherein said permanent buffer is a hard drive.

50. The system of claim 24, further comprising a database for storing said program information corresponding to each of said plurality of media content instances.

51. A graphical user interface (GUI) displayed on a display device, said GUI comprising:
a single channel program guide, said single channel program guide displaying program information corresponding to each of a plurality of media content instances included in media content being broadcast on said channel during a number of time segments; and
a progress bar configured to graphically represent the duration of a recorded portion of said media content.

52. The GUI of claim 51, wherein said media content is displayed on said display device at the same time as said single channel program guide and said progress bar.

53. The GUI of claim 51, wherein said media content instances comprise television programs.

54. The GUI of claim 51, wherein said number of time segments is user-definable.

55. The GUI of claim 51, wherein the duration of each of said time segments is user-definable.

56. The GUI of claim 51, wherein said single channel program guide further displays a time scale corresponding to said number of time segments.

57. The GUI of claim 51, wherein said program information comprises a title for each of said plurality of said media content instances.

58. The GUI of claim 51, wherein said program information is superimposed on top of said single channel program guide.

59. The GUI of claim 51, further comprising one or more scroll bars to scroll said single channel guide backwards and forwards such that additional time segments and corresponding program information are visible to a user.

60. The GUI of claim 51, wherein said progress bar is superimposed on top of said single channel program guide.

61. The GUI of claim 51, wherein said recorded portion of said media content is stored in a live cache buffer.

62. The GUI of claim 61, wherein said live cache buffer is configured to store a pre-determined quantity of said media content, said pre-determined quantity corresponding to a live cache time window.

63. The GUI of claim 62, wherein the size of said live cache time window is user-definable.

64. The GUI of claim 51, wherein the length of said progress bar increases as time advances.

65. The GUI of claim 51, wherein said progress bar is further configured to allow a user to view said recorded portion of said media content in a trick play mode.

66. The GUI of claim 51, further comprising a progress indicator configured to correspond to a position in time of a particular media content instance currently being displayed on said display device, said position in time relative to said duration of said recorded portion of said media content.

67. The GUI of claim 66, wherein said progress indicator is a vertical line superimposed on top of said single channel program guide.

68. The GUI of claim 66, wherein said progress indicator is a triangle.

69. A system for providing information about media content being broadcast on a channel during a number of time segments, said system comprising:
means for displaying a single channel program guide, said single channel program guide showing program information corresponding to each of a plurality of media content instances included in said media content; and
means for displaying a progress bar to graphically represent the duration of a recorded portion of said media content that has been stored in a live cache buffer.

70. The system of claim 69, further comprising means for displaying said media content at the same time as said single channel program guide and said progress bar.

71. The system of claim 69, wherein said means for displaying said single channel program guide further comprises means for displaying a time scale corresponding to said number of time segments.

72. The system of claim 69, further comprising means for displaying said program information such that said program information is superimposed on top of said single channel program guide.

73. The system of claim 69, further comprising means for displaying one or more scroll bars configured to scroll said single channel guide backwards and forwards such that additional time segments and corresponding program information are visible to a user.

74. The system of claim 69, further comprising means for displaying a progress indicator corresponding to a position in time of a particular media content instance currently being displayed, said position in time relative to said duration of said recorded portion of said media content.

75. The system of claim 74, further comprising means for permanently recording in a permanent buffer one of said media content instances that has been stored in said live cache buffer.

76. The system of claim 75, wherein said means for permanently recording one of said media content instances comprises:
means for positioning said progress indicator to a location within any portion of said progress bar corresponding to said one of said media content instances;
means for receiving an instruction to record from a user input device; and
means for copying said one of said media content instances from said live cache buffer to said permanent buffer.

77. The system of claim 76, wherein said means for copying said one of said media content instances comprises:
means for dereferencing said location of said progress indicator to a real time stamp;
means for determining a start time and a stop time of said one of said media content instances by comparing said real time stamp to said program information; and
means for copying data corresponding to media content between said start and stop times from said live cache buffer to said permanent buffer.

78. The system of claim 75, wherein said means for permanently recording in a permanent buffer one of said media content instances that has been stored in said live cache buffer further comprises means for permanently recording said program information corresponding to said one of said media content instances.
